(19) United States
(12) Patent Application Publication
(10) Pub. No.: US 2004/0030683 A1
(43) Pub. Date: Feb. 12, 2004

(54) System and process for mediated crawling

(76) Inventors: Philip Clark Evans, Seattle, WA (US); Robin Andrew Alexander, Redmond, WA (US); Paul Thurmond Shannon, Seattle, WA (US)

Correspondence Address: Joseph S Tripoli, Thomson Multimedia Licensing Inc, PO Box 5312, Princeton, NJ, 08543-5312, US

(21) Appl. No.: 10/432,388

(22) PCT Filed: Nov. 20, 2001
(86) PCT No.: PCT/US01/43248

(30) Foreign Application Priority Data
Nov. 21, 2000 (US) 60252273

(51) Int. Cl. G06F 7/00

(52) U.S. Cl. 707/3

(57) ABSTRACT

A system and method for searching networked based content limits searching unnecessary content. The first time a web site is encountered, an exhaustive search is conducted (522), and a site map (300) is generated (524) and the URL of the web site is added to a directory of encountered web sites (526). The next time the web site is encountered, the system utilizes the site map and directory to search only for relevant content (614). Web sites are revisited, in accordance with information derived from previous visits, to conduct subsequent exhaustive searches in order to update the site map and directory. A site map includes a structured data storage format, wherein content of the web site is organized in levels.

The field of this invention relates generally to computer related information search and retrieval, and more specifically to a structured search of content on a network.

As background to understanding the invention, an aspect of the Internet (also referred to as the World Wide Web, or Web) contributing to its popularity is the plethora of multimedia and streaming media files available to users. However, finding a specific multimedia or streaming media file buried among the millions of files on the Web is often an extremely difficult task. The volume and variety of informational content available on the web is likely to continue to increase at a rather substantial pace. This growth, combined with the highly decentralized nature of the web, creates substantial difficulty in locating particular informational content.

Streaming media refers to audio, video, multimedia, textual, and interactive data files that are delivered to a user's computer via the Internet or other network environment and begin to play on the user's computer before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, less expensive high-bandwidth connections such as cable, DSL and T1 are providing Internet users with speedier, more reliable access to streaming media content from news organizations, Hollywood studios, independent producers, record labels and even home users.

A user typically searches for specific information on the Internet via a search engine. A search engine comprises a set of programs accessible at a network site within a communications network, for example a local area network (LAN) or the Internet and World Wide Web. One program, called a “robot” or “spider”, pre-traverses a network in search of documents (e.g., web pages) and builds large index files of keywords found in the documents. Typically, a user formulates a query comprising one or more search terms and submits the query to another program of the search engine. In response, the search engine inspects its own index files and displays a list of documents that match the search query, typically as hyperlinks. The user may then activate one of the hyperlinks to see the information contained in the document.

Search engines, however, have drawbacks. For example, many typical search engines are oriented to discover textual information only. In particular, they are not well suited for indexing information contained in structured databases (e.g. relational databases), voice related information, audio related information, multimedia, and streaming media, etc. Also, mixing data from incompatible data sources is difficult for conventional search engines. Also, when the search engine searches (also referred to as crawls) a network, it typically conducts the crawl in a random fashion by following the web links it encounters. Typically, the search engine (e.g., web crawler) catalogs complete web sites. This inefficient type of search often generates a large amount of data, which is unnecessary for the use of generating a searchable index. This is especially applicable to objects such as streaming media.

The invention is a method for searching network based content for target content includes determining selected levels of a structured data store for searching for content related to the target content. The method also includes searching the selected levels for content related to the target content.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1 is a stylized overview illustration of a system of interconnected computer system networks;

FIG. 2 is a block diagram of an exemplary structured format for a data store in accordance with an embodiment of the invention;

FIG. 3 is a block diagram of exemplary site map in accordance with an embodiment of the invention;

FIG. 4 is an illustration of information stored in a database 400 in accordance with an exemplary embodiment of the present invention; and

FIG. 5 is a flow diagram of an exemplary search process in accordance with the present invention.

The Internet is a worldwide system of computer networks that is a network of networks in which users at one computer can obtain information from any other computer and communicate with users of other computers. The most widely used part of the Internet is the World Wide Web (often-abbreviated “WWW” or called “the Web”). An outstanding feature of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser; such as NETSCAPE NAVIGATOR® and MICROSOFT INTERNET EXPLORER®. The appearance of a particular website may vary slightly depending on the particular browser used. Recent versions of browsers have “plug-ins,” which provide animation, virtual reality, sound and music.

The present invention is a method and a system for retrieving network based content, including media files and data related to media files, on a computer network via a search system utilizing metadata. As used herein, the term “media file” includes audio, video, textual, multimedia data files, and streaming media files. Multimedia files comprise any combination of text, image, video, and audio data. Streaming media comprises audio, video, multimedia, textual, and interactive data files that are delivered to a user's computer via the Internet or other communications network environment and begin to play on the user's computer/device before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, the reduction in cost of communications networks through the use of high-bandwidth connections such as cable, DSL, T1 lines and wireless networks (e.g., 2.5G or 3G based cellular networks) are providing Internet users with speedier, more reliable access to streaming media content from news organizations, Hollywood studios, independent producers, record labels and even home users themselves.

Examples of streaming media include songs, political speeches, news broadcasts, movie trailers, live broadcasts, radio broadcasts, financial conference calls, live concerts, web-cam footage, and other special events. Streaming media is encoded in various formats including REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3®. Typically, media files are designated with extensions (suffixes) indicating compatibility with specific formats. For example, media files (e.g., audio and video files) ending in one of the extensions, .ram, .rm, .rpm, are compatible with the REALMEDIA® format. Some examples of file extensions and their compatible formats are listed in the following table. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT | .wma, .cmr, .avi |
| WINDOWS ® MEDIA | |
| PLAYER | |
| MACROMEDIA FLASH | .swf, .swl |
| MPEG | .mpg, .mpa, .mp1, |
| | .mp2 |
| MPEG-2 LAYER III | .mp3, .m3a, .m3u |
| Audio | |

Metadata as descriptive data literally means “data about data.” Metadata is data that comprises information that describes the contents or attributes of other data (e.g., media file). For example, a document entitled, “Dublin Core Metadata for Resource Discovery,” (http://www.ietf.org/rfc/rfc2413.txt) separates metadata into three groups, which roughly indicate the class or scope of information contained therein. These three groups are: (1) elements related primarily to the content of the resource, (2) elements related primarily to the resource when viewed as intellectual property, and (3) elements related primarily to the instantiation of the resource. Examples of metadata falling into these groups are shown in the following table.

TABLE 2

| | Intellectual | |
|---|---|---|
| Content | Property | Instantiation |
| Title | Creator | Date |
| Subject | Publisher | Format |
| Description | Contributor | Identifier |
| Type | Rights | Language |
| Source | | |
| Relation | | |
| Coverage | | |

Sources of metadata include web page content, uniform resource indicators (URIs), media files, and transport streams used to transmit media files. Web page content includes HTML, XML, metatags, and any other text on the web page. As explained in more detail, herein, metadata may also be obtained from the URIs, uniform resource locators (URLs) the web page, media files, and other metadata. Metadata within the media file may include information contained in the media file, such as in a header or trailer, of a multimedia or streaming file, for example. Metadata may also be obtained from the media/metadata transport stream, such as TCP/IP (e.g., packets), ATM, frame relay, cellular based transport schemes (e.g., cellular based telephone schemes), MPEG transport, HDTV broadcast, and wireless based transport, for example. Metadata may also be transmitted in a stream in parallel or as part of the stream used to transmit a media file (a High Definition television broadcast is transmitted on one stream and metadata, in the form of an electronic programming guide, is transmitted on a second stream).

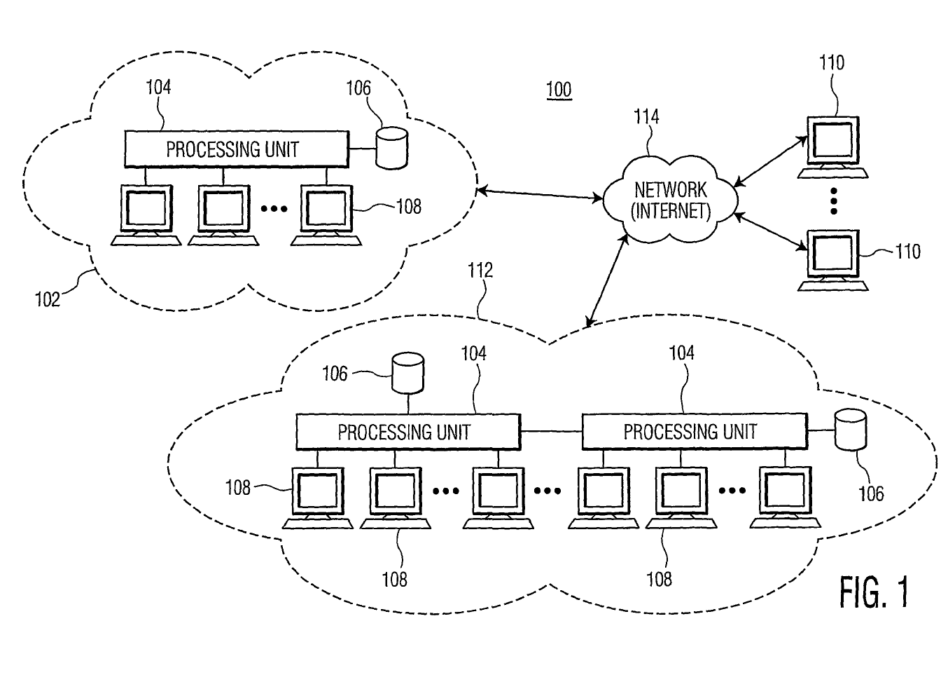

Referring to FIG. 1 there is shown a stylized overview of a system 100 of interconnected computer system networks 102 and 112. Each computer system network 102 and 112 contains at least one corresponding local computer processor unit 104 (e.g., server), which is coupled to at least one corresponding local data storage unit 106 (e.g., database), and local network users 108. A computer system network may be a local area network (LAN) 102 or a wide area network (WAN) 112, for example. The local computer processor units 104 are selectively coupled to a plurality of media devices 110 through the network (e.g., Internet) 114. Each of the plurality of local computer processors 104, the network user processors 108, and/or the media devices 110 may have various devices connected to its local computer systems, such as scanners, bar code readers, printers, and other interface devices. A local computer processor 104, network user processor 108, and/or media device 110, programmed with a Web browser, locates and selects (e.g., by clicking with a mouse) a particular Web page, the content of which is located on the local data storage unit 106 of a computer system network 102, 112, in order to access the content of the Web page. The Web page may contain links to other computer systems and other Web pages.

The local computer processor 104, the network user processor 108, and/or the media device 110 may be a computer terminal, a pager which can communicate through the Internet using the Internet Protocol (IP), a Kiosk with Internet access, a connected electronic planner (e.g., a PALM device manufactured by Palm, Inc.) or other device capable of interactive communication through a network, such as an electronic personal planner. The local computer processor 104, the network user processor 108, and/or the media device 110 may also be a wireless device, such as a hand held unit (e.g., cellular telephone), that connects to and communicates through the Internet using the wireless access protocol (WAP). Networks 102 and 112 may be connected to the network 114 by a modem connection, a Local Area Network (LAN), cable modem, digital subscriber line (DSL), twisted pair, wireless based interface (cellular, infrared, radio waves), or equivalent connection utilizing data signals. Databases 106 may be connected to the local computer processor units 104 by any means known in the art. Databases 106 may take the form of any appropriate type of memory (e.g., magnetic, optical, etc.). Databases 106 may be external memory or located within the local computer processor 104, the network user processor 108, and/or the media device 110.

Computers may also encompass computers embedded within consumer products and other computers. For example, an embodiment of the present invention may comprise computers (as a processor) embedded within a television, a set top box, an audio/video receiver, a CD player, a VCR, a DVD player, a multimedia enable device (e.g., telephone), and an Internet enabled device.

In an exemplary embodiment of the invention, the network user processors 108 and/or media devices 110 include one or more program modules and one or more databases that allow user processors 108 and/or media devices 110 to communicate with the local processor 104, and each other, over the network 114. The program module(s) include program code, written in PERL, Extensible Markup Language (XML), Java, Hypertext Mark-up Language (HTML), any other equivalent language which allows network user processors 108 to access the program module(s) of the local processors 104 through the browser programs stored on the network user processors 108, or any combination thereof.

Web sites and web pages are locations on a network, such as the Internet, where information (content) resides. A web site may comprise a single or several web pages. A web page is identified by a Uniform Resource Locator (URL), as an example of a URI, comprising the location (address) of the web page on the network. Web sites, and web pages, may be located on local area network 102, wide area network 112, network 114, processing units (e.g., servers) 104, user processors 108, and/or media devices 110. Information, or content, may be stored in any storage device, such as a hard drive, compact disc, and mainframe device, for example. Content may be stored in various formats, which may differ, from web site to web site, from web page to web page, and even within a web page.

Typically, when searching content on a network, an agent, such as a web crawler or robot, crawls (searches) the network in a quasi-random fashion, following each web link it encounters. Crawling is but one illustrative example of collecting descriptive data, such as metadata, from a network. This type of quasi-random search process often results in a large amount of unnecessary data being searched. The inventors have discovered a technique, wherein searching is limited to avoid searching unnecessary content. Briefly, the first time a web site (or any location of content, such as a file directory) is encountered, an exhaustive search is conducted, and a site map is generated. Also, the URL of the web site is added to a directory of encountered web sites. The next time the web site is encountered, the agent utilizes the directory and the respective site map to search only for relevant content (referred to as a focused crawl). Also, because of the dynamic nature of the Internet, web sites are revisited from time to time to conduct another exhaustive search/crawl in order to update the site map and the directory. A site map comprises a structured data storage format, wherein content of the web site (or file directory) is organized in levels (also referred to as layers).

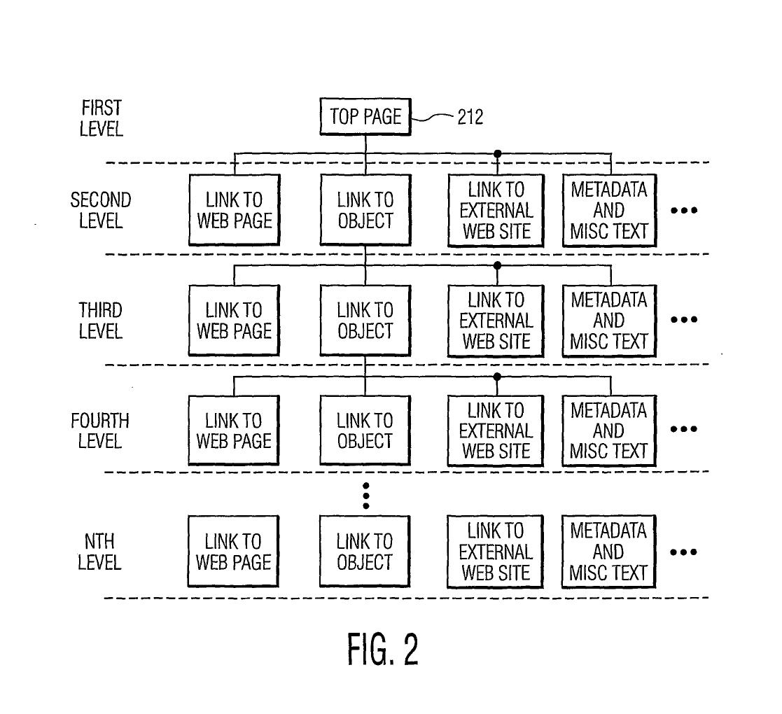

FIG. 2 is a block diagram of an exemplary structured format for a data store in accordance with an embodiment of the invention. The structured data store is formatted into levels. The structured data store may comprise any number of levels. Each level of a data store may comprise any number of links, objects, metadata, miscellaneous text, or any combination thereof, related to common content. An object is a searchable entity on the network. For example, an object may be a multimedia file or a streaming media file. In one exemplary embodiment of the invention, each level represents a web page, another web site, an object (e.g., multimedia, streaming media), metadata, miscellaneous text, or any combination thereof, encountered while conducting a search on a particular web site. More specifically, each level comprises links to a web page, another web site, an object, metadata, miscellaneous text, or any combination thereof. For example, as shown in FIG. 2, the first level represents the home page of a web site (e.g., top page 212). Top page 212 may comprise information such as the URL of the home page of the web site and, optionally, a list of the URLs contained on the web site. The second level represents the next web page encountered at that web site while conducting the search. The third level represents the next web page, at that web site, encountered upon exiting the second level, while conducting the search. The number of levels and/or the content of each level are reconfigurable. That is, the number of levels and/or the content of each level may be updated periodically, and/or as desired.

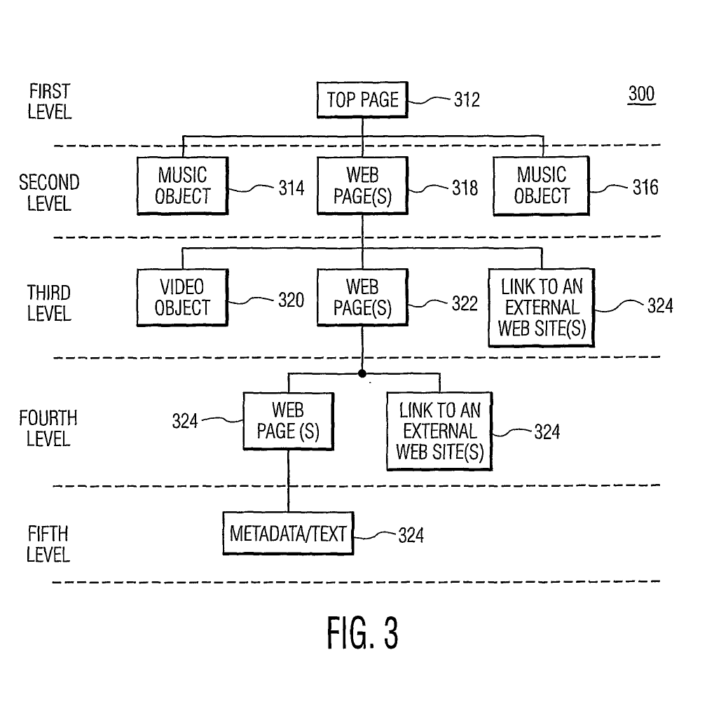

A site map comprises content of a web site formatted in accordance with a structured data store format. FIG. 3 is a block diagram of exemplary site map 300 in accordance with an embodiment of the invention. Site map 300 is formatted into five levels. The five levels correspond to web pages of the encountered web site. The first level of site map 300 comprises the top page 312 (home page). The top page 312 comprises the URL of the home page of the web site and may comprise other information such as the URLs of the web pages at this web site. The second level of site map 300 comprises content located on the next level web page down from the home page. The second level of site map 300 comprises music objects 314 and 316, and web page(s) 318. Objects 314 and 316 represent links to music objects contained on this web site. Web page(s) 318 comprises a list of URLs for the web pages on this web site having music media objects. The third level of site map 300 comprises content having the common attribute of video media. The third level of site map 300 comprises video object 320, web page(s) 322, and link(s) to external web site(s) 324. Object 320 represents a link to a video object contained on this web site. Web page(s) 322 comprises a list of URLs for the web pages on this web site having video media objects. Link(s) to external web site(s) 324 comprises URLs of other web sites comprising objects and/or metadata pertaining to video objects. The fourth level of site map 300 comprises web page(s) 326 and link(s) to external web site(s) 328. The fifth level of site map 300 comprises metadata related to target content and textual data.

The format of site map 300 is exemplary. A site map in accordance with the present invention may comprise more or less than five levels. In one embodiment of the invention, each web site encountered for the first time is exhaustively searched (e.g., crawled) and the corresponding created site map comprises as many levels as necessary to encompass all the entities (e.g., objects, web pages, external web sites, metadata, text) contained at that web site. In another embodiment of the invention, the number of levels in the site map is set not to exceed a predetermined threshold. For example, the number of levels in a single site map may be set not to exceed three. In yet another embodiment of the invention, the number of levels in a site map is heuristically determined. For example, a specific web site may be exhaustively searched upon first being encountered and it is determined that six levels comprise information related to streaming media and/or multimedia (i.e., the target content). The same web site may be revisited to conduct additional exhaustive searches at later times. Through this heuristic technique it may be determined that streaming media and/or multimedia content are consistently encompassed in a site map comprising six levels. Thus, the number of levels for the site map of this example is set to six.

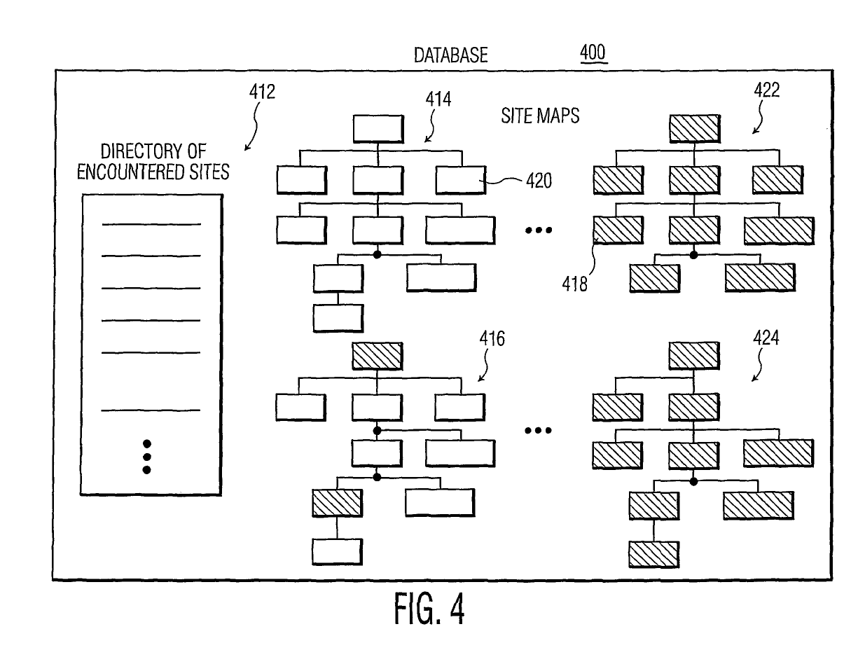

As web sites are first encountered, site maps are created and information pertaining to the encountered web sites and corresponding site maps is stored in a database. FIG. 4 is an illustration of information stored in a database 400 in accordance with an exemplary embodiment of the present invention. During the search process for target content, various web sites are encountered. The first time a web site is encountered a site map is created for that encountered web site. Each site map (e.g., site maps 414, 416) is stored in a database 400. To determine if a web site was previously encountered, indicating that a site map exists in the database for that web site, each encountered web site is compared with a directory 412 of encountered web sites. The directory 412 of encountered web sites comprises the URL of each encountered web site for which a site map has been created and information pertaining to the content of each web site. The directory 412 of encountered web sites is reconfigurable, and is continuously updated as new site maps are created and/or deleted.

In accordance with the present invention, web sites are searched for target content. Target content comprises a specific term being searched for, and information related to that term. Databases are formed using the results of the web site searches. In order to form these databases, the web sites are not searched in a random fashion, rather a focused search process is conducted. Historical data (e.g., how often a site has been visited, how many users have visited a site), and metadata are utilized to aid in the search. Furthermore, if a web site has been previously encountered and a site map exists for that web site, the website is not exhaustively searched; a focused search process is conducted. A focused search (also referred to as a focused crawl) process comprises searching only web sites and/or entities of the site map that have previously been determined to contain content pertaining to the target content. As shown in FIG. 4, striped entities, such as entity 418, represent entities containing content related to the target content. Un-striped entities, such as entity 420, represent entities not containing content pertaining to the target content. Also, site maps 422 and 424 contain much more content pertaining to the target content than do site maps 414 and 416. Accordingly, during a focused search, a system in accordance with the present invention searches the striped entities (e.g., 418) of the site maps (e.g., 422 and 424).

Note that site map 416 comprises more striped entities than site map 414, and less than either of site maps 422 and 424. Depending upon the values of predetermined thresholds, site map may or may not be searched during a focused search process. Thresholds include the maximum number of web sites to be searched, the maximum number of levels to be searched, the maximum number of entities to be searched, and/or the maximum amount of data to be retrieved as a result of a search. In an exemplary embodiment of the invention, values for each of these thresholds are determined heuristically.

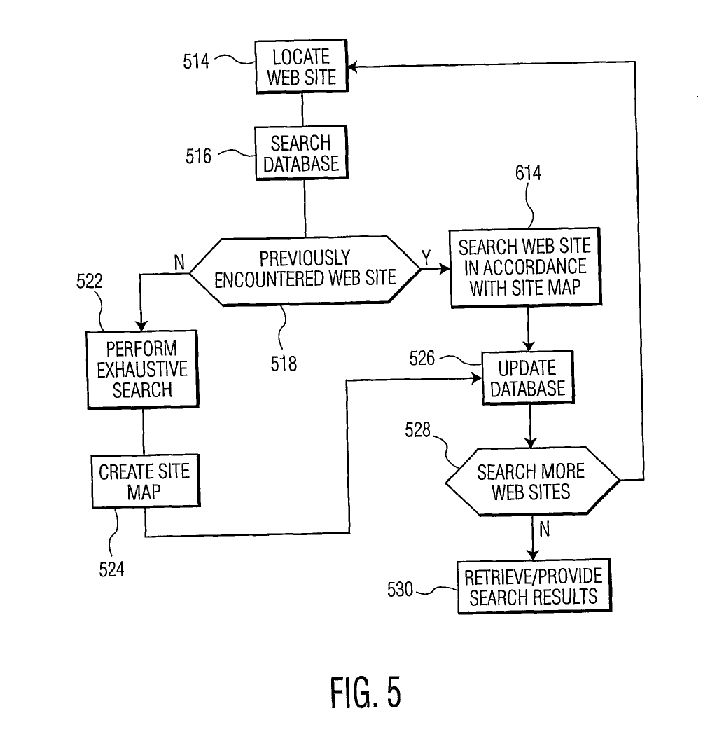

In FIG. 5 is shown a flow diagram of an exemplary search process in accordance with the present invention. A spider or other appropriate agent searches a web site for target content. A web site comprising target is located at step 514. At step 516, database 400 is searched to determine if the located web site is a previously encountered web site. If the located web site is a previously encountered web site, then, at step 518, the system decides to conduct a focused search in accordance with the site map indicative of that web site. If the located web site is not a previously encountered web site, the system decides, at step 518, not to conduct a focused search, but rather perform an exhaustive search of the web site. If it is determined that the located web site is not a previously encountered web site, an exhaustive search is conducted of that web site at step 522. Accordingly, a site map is created at step 524. At step 526, database 400 is updated to include the newly created site map, and encountered site directory 412 is also updated to include the URL of the newly encountered web site. If no thresholds have been met, it is determined, at step 528, to search for more web sites comprising target content. Once a web site is located, the process continues from step 514. If a threshold has been met (such as total number of web sites searched, for example), then, it is decided at step 528, to retrieve and provide the results of the search for the target content to the system, user, and/or another search system (step 530).

If it is decided (at step 518) that a focused search is to be conducted, the located web site is searched in accordance with its respective site map at step 614. Database 400 is updated at step 526, to update the respective site map and encountered site directory 412, as appropriate. For example, if a database 400 indicates that a particular web site comprises content related to the target content, the respective site map is used to search only the entities comprising content related to the target content. If is discovered that the particular web site no longer comprises content related to the target content, the site map is removed from the database 400, and the URL of that web site is removed from the site directory 412. If no thresholds have been met, it is determined, at step 528, to search for more web sites comprising target content. Once a web site is located, the process continues from step 514. If a threshold has been met (such as total number of web sites searched, for example), then, it is decided at step 528, to retrieve and provide the results of the search for the target content to the system, user, and/or another search system (step 530).

In another exemplary embodiment of the invention, the system 100 stores auxiliary information pertaining to the encountered web sites in database 400. This auxiliary information is used to determine threshold values such as the maximum number of web sites to be searched, the maximum number of levels to be searched, the maximum number of entities to be searched, and/or the maximum amount of data to be retrieved as a result of a search, for example. These threshold values may be determined statistically, heuristically, and/or by user input.

In yet another exemplary embodiment of the invention, the system 100 conducts subsequent extensive searches (referred to as recrawl) of previously encountered web sites to update the database 400 (e.g., update a web site's respective site map, update the directory of encountered sites 412, delete a site map, delete a URL from the directory 412). The system uses the auxiliary information to determine how often to conduct a recrawl. How often and when a recrawl is to be conducted may be determined statistically, heuristically, and/or by user input.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

A system 100 in accordance with the present invention searches a network for target content in a more efficient manner than prior art search agents. The system 100 provides a targeted search in accordance with site maps, providing a more efficient search by eliminating a search of web sites and directories within web sites that do not contain content related to the target content. This is especially applicable to target content pertaining to content that is not contained in a majority of web sites and/or directories within web sites (e.g., streaming media). Further, a system 100, in accordance with the present invention, utilizes statistically and/or heuristically determined criteria to conduct subsequent searches to ensure the accuracy of the system's database.

What is claimed is:

1. A method for searching network based content for target content, said method comprising the steps of:
determining selected levels of a structured data store for searching for content related to said target content, wherein said structured data store comprises network based content; and
searching said selected levels for content related to said target content.

2. A method in accordance with claim 1, wherein said target content comprises at least one of multimedia, streaming media, multimedia metadata, and streaming media metadata.

3. A method in accordance with claim 1, further comprising the step of creating said structured data store.

4. A method in accordance with claim 1, further comprising the step of determining a time interval for updating said structured data store.

5. A method in accordance with claim 1, further comprising the steps of:
searching at least one network site for content related to said target content; and
creating a respective site map for each newly encountered network site.

6. A method in accordance with claim 5, wherein each site map comprises at least one level, each level comprising at least one of a link, an object, and metadata related to common content.

7. A method in accordance with claim 5, wherein said data store comprises a respective site map for each encountered network site and a directory of encountered network sites.

8. A method in accordance with claim 5, further comprising the steps of:
determining if an encountered network site is a previously encountered network site;
if an encountered network site is a previously encountered network site, searching selected levels of a respective site map; and
if an encountered network site is not a previously encountered network site, exhaustively searching that network site for said target content and creating a respective site map.

9. A computer system for searching network based content for target content, said computer system comprising at least one computer, all computers in said system being communicatively coupled to each other, wherein each of said at least one computer includes at least one program stored therein for allowing communication between each and every of said at least one computer, each of said at least one program operating in conjunction with one another to cause said at least one computer to perform the steps of:
determining selected levels of a structured data store for searching for content related to said target content (516), wherein said structured data store comprises network based content; and
searching said selected levels for content related to said target content.

10. A computer system in accordance with claim 9, wherein said target content comprises at least one of multimedia, streaming media, multimedia metadata, and streaming media metadata.

11. A computer system in accordance with claim 9, wherein each of said at least one program operating in conjunction with one another causes said at least one computer to further perform the step of creating said structured data store.

12. A computer system in accordance with claim 9, wherein each of said at least one program operating in conjunction with one another causes said at least one computer to further perform the step of determining a time interval for updating said structured data store.

13. A computer system in accordance with claim 9, wherein each of said at least one program operating in conjunction with one another causes said at least one computer to further perform the steps of:
searching at least one network site for content related to said target content (522); and
creating a respective site map for each newly encountered network site (524).

14. A computer system in accordance with claim 13, wherein each site map comprises at least one level, each level comprising at least one of a link, an object, and metadata related to common content.

15. A computer system in accordance with claim 13, wherein said data store comprises a respective site map for each encountered network site and a directory of encountered network sites.

16. A computer system in accordance with claim 13, wherein each of said at least one program operating in conjunction with one another causes said at least one computer to further perform the steps of:
determining if an encountered network site is a previously encountered network site;
if an encountered network site is a previously encountered network site, searching selected levels of a respective site map; and
if an encountered network site is not a previously encountered network site, exhaustively searching that network site for said target content and creating a respective site map.

17. A program readable medium having embodied thereon a program for causing a processor to search network based content for target content, said program readable medium comprising:
means for causing said processor to determine selected levels of a structured data store for searching for content related to said target content, wherein said structured data store comprises network based content; and
means for causing said processor to search said selected levels for content related to said target content.

18. A program readable medium in accordance with claim 17, wherein said target content comprises at least one of multimedia, streaming media, multimedia metadata, and streaming media metadata.

19. A program readable medium in accordance with claim 17, said program readable medium further comprising means for causing said processor to create said structured data store.

20. A program readable medium in accordance with claim 17, said program readable medium further comprising means for causing said processor to determine a time interval for updating said structured data store.

21. A program readable medium in accordance with claim 17, said program readable medium further comprising:
means for causing said processor to search at least one network site for content related to said target content; and
means for causing said processor to create a respective site map for each newly encountered network site.

22. A program readable medium in accordance with claim 21, wherein each site map comprises at least one level, each level comprising at least one of a link, an object, and metadata related to common content.

23. A program readable medium in accordance with claim 21, wherein said data store comprises a respective site map for each encountered network site and a directory of encountered network sites.

24. A program readable medium in accordance with claim 21, said program readable medium further comprising:
means for causing said processor to determine if an encountered network site is a previously encountered network site;
if a network site is a previously encountered network site, means for causing said processor to search selected levels of a respective site map; and
if a network site is not a previously encountered network site, means for causing said processor to exhaustively search that network site for said target content and creating a respective site map.

25. A data signal embodied in a carrier wave comprising:
a determine selected level code segment for determining selected levels of a structured data store for searching for content related to said target content, wherein said structured data store comprises network based content; and
a search selected level code segment for searching said selected levels for content related to said target content.

26. A data signal in accordance with claim 25, wherein said target content comprises at least one of multimedia, streaming media, multimedia metadata, and streaming media metadata.

27. A data signal in accordance with claim 25, further comprising a create data store code segment for creating said structured data store.

28. A data signal in accordance with claim 25, further comprising a determine time interval code segment for determining a time interval for updating said structured data store.

29. A data signal in accordance with claim 25, further comprising:
a search network code segment for searching at least one network site for content related to said target content; and
a create site map code segment for creating a respective site map for each newly encountered network site.

30. A data signal in accordance with claim 29, wherein each site map comprises at least one level, each level comprising at least one of a link, an object, and metadata related to common content.

31. A data signal in accordance with claim 29, wherein said data store comprises a respective site map for each encountered network site and a directory of encountered network sites.

32. A data signal in accordance with claim 29, further comprising:
a determine previously encountered network code segment for determining if an encountered network site is a previously encountered network site;
if an encountered network site is a previously encountered network site, a search level code segment for searching selected levels of a respective site map; and
if an encountered network site is not a previously encountered network site, a search network site code segment for exhaustively searching that network site for said target content and creating a respective site map.
